(19) United States
(12) Patent Application Publication
(10) Pub. No.: US 2010/0265629 A1
(43) Pub. Date: Oct. 21, 2010

(54) Relay Coil Drive Circuit

(76) Inventor: Howard Beckerman, Red Bank, NJ (US)

Correspondence Address: HOWARD BECKERMAN, 61 RIORDAN PLACE, SHREWSBURY, NJ, 07702, US

(21) Appl. No.: 12/425,258

(22) Filed: Apr. 16, 2009

(51) Int. Cl. H01H 47/22

(52) U.S. Cl. 361/160

(57) ABSTRACT

Relay contacts operate with a snap action when disclosed electronic waveforms, profile its coil current. Snap action reduces the prolonged low pressure that damages relay contacts. This means of driving the relay coil also reverses the properties of its voltage and current. Coil voltage now varies with movement of its armature, frame current, coil resistance, back-EMF, and temperature. Coil current follows a profile that is stable and independent of these changing electrical, mechanical, and environmental factors. Since coil voltage has no direct magnetic or mechanical effect its changes do not affect relay operation. However the relays new stable current profile has a dramatic affect. It moves, makes, breaks and seats predictably, regardless of its temperature, residual magnetism, or mechanical wear. Power-line synchronization means takes advantage of this new stability, concentrating on the position and pressure of the contact. The contact starts to move closed after the peak power-line voltage and makes at zero voltage. Full contact pressure is maintained until load-current is near zero and contact break occurs before zero current. Several types of coil current profiles are disclosed along with analog and software controlled embodiments. New relay friendly electronic reset logic is disclosed to maintain contact pressure during power losses caused by load-surge and load-shorts. Zero crossing and power-line voltage are combined with logic that does not disable but delays relay operation. Relay contact to coil noise problems are disclosed along with suppression techniques to stop electronic circuitry induced contact chatter. Diagnostic techniques and production methods are disclosed for relays that are sealed inside an enclosure. Automatic and manual timing adjustment means are also disclosed.

### BACKGROUND OF THE INVENTION

The technical field of this invention relates to a method of using pc-relays to run loads normally reserved for larger industrial contactors. An industrial contactor is not just a bigger relay; at its heart is a powerful solenoid with an ability to deliver lots of force. It hammers contacts together to make an electrical connection and then hammers apart the contacts breaking that connection. Worn, pitted, or dirty contacts make a solid electrical connection because mashing the conductors together forces irregular surfaces to mate. Remove coil power from the contactor and a set of stiff springs accelerate its massive armature into the made contacts, breaking apart contact welds. Years of experience proves this method of operation to be very reliable. In the home, contactors operate air conditioners, pumps and other motor loads. In industry they are used to control nearly every load. As a result there are hundreds of millions in operation and millions more are produced every year.

The undesirable aspects of the contactor are that it is large and heavy, and all this hammering requires a significant amount of power to operate. A small contactor requires 40-VA (volt-amperes) of inrush and dissipates 12-watts of power as heat while operating. Customarily they use a safer coil voltage, usually 24-volts AC, and the resulting transformer can be larger, heavier and waste more power than the contactor itself. When a contactor operates it makes a loud noise and it also has a limited life, typically around 100,000-cycles on motor loads. There is significant value in using printed circuit board relays (PC-relays) with electronic circuitry instead of a contactor. PC-relays rated at the same current and voltage as a contactor cost less, occupy less space, less weight, and have lower power requirements. PC-relays are so small that they, their power supply and the electronics can all reside on the same circuit board. A typical relay uses 0.5-W of coil power and since they utilize a printed circuit board there is less hand wiring. Low heat dissipation and small size allows PC-relays to be sealed inside plastic housings making them immune to dirt, humidity and corrosion.

Efficiency is the issue of this millennium such that a lot more effort and cost is going into reducing wasted energy. In this invention a pc-relay using half a watt replaces a contactor using 12-W. The saving might not seem like much but multiplied by millions of loads it becomes significant. Pc-relays have an even larger energy advantage over solid state electronic relays. At 40-amps, solid state relays waste 60-watts, due to their inherent voltage drop and cooling fans add to these losses. A savings in energy is historically accompanied by an increase in cost. This invention manages to decrease cost and save energy. However, the problems associated with using PC-relays to control motor loads are considerable and for the most part hidden. Failures occur in situations far below their ratings, defying conventional wisdom. Some of these problems may be rationalized since they lack the hammer action and raw power of the industrial contactor. But pc-relays also seem to be less reliable than ordinary switches such as wall switches, limit switches, or even temperature switches. Careful and thorough testing reveals that certain important information is missing or is not commonly known about these relays. It is briefly presented here to aid in the understanding of the invention.

Relays, including contactors, use two springs; one separates the contacts using a minimum low force and the other applies pressure between the contacts with a much higher force. For example, in FIG. 1 at move (16), the relay's bent spring (19) exerts a low force separating the contacts across a large magnetic gap (S). When the magnetic gap gets smaller, at make (17) and more magnetic force is available a second stiffer spring engages, leaf spring (20). It can be seen that when the armature seats (18), leaf spring (20) applies pressure between the contacts (2 & 3) and accommodates contact wear. The two spring system is a balance between spring and magnetic forces. Relay coil (6) current must produce enough magnetic force on the armature (4) to bend both springs across their respective gap distances. This follows a formula in which the magnetic force (F) produced by the relay coil is proportional to its ampere-turns (iT) divided by the magnetic gap distance (S) squared.

$$F = K \frac{i T}{{S}^{2}}$$

Ampere-turns (iT), is the current times the number of wire turns in the coil, for example in the pc-relay of FIG. 1, 200-iT might be accomplished with 2,000-turns at 0.1-amp. Constant (K) is measured by applying a known amount of ampere-turns at known gap distances and measuring the force produced on the armature. The formula does not contain a voltage term since coil voltage serves as a means of producing coil current but otherwise has no direct magnetic or mechanical effect. As the armature moves from fully open (16) to make at (17) the magnetic gap (S) becomes 2.5-times smaller allowing the springs to be (S²) 6-times stiffer than bent spring (19) alone. When the armature seats at (18), (S) is still not zero. Imperfect alignment, surface roughness, flatness, dust, and non-magnetic coatings all add up to some small gap. A Pc-relay's tight tolerance, smooth finish, and sealed enclosure afford it a small seated gap. Rivaling the contactor in force at far lower ampere-turns.

Relay contact design is obvious; bigger contact gaps increase its voltage rating while higher contact pressures and thicker metals increase its current rating. Its rating can also be improved without changing its size. Substituting a dielectric gas inside its sealed case, instead of air, multiplies its voltage handling capability. Such gases are well known and include nitrogen, sulfur-hexafluoride (SF6), and most refrigerants. A stiffer, thicker leaf spring (20) allows a higher current if gap distances are decreased. These design and magnetic force assertions are a static (non-moving) statement of relay operation. Dynamically (in-motion) several major problems develop. In FIG. 2; switch (21) closes at time zero connecting a voltage (22) across relay coil (6). Voltage instantly appears across the coil. However graph (23) shows that coil current is delayed and more importantly varies with relay armature movement and temperature. Varying the ampere-turns and the magnetic force pulling on the armature while it's moving. In graph (23) the current begins to rise at time zero until the magnetic force across the gap exceeds the opposing force of bent spring (19) and the armature begins to move (16).

As the armature accelerates it closes the gap and the magnetic force attracting the armature attempts to increase. Like a permanent magnet when a steel bar gets close, the force between them increases. Unlike a permanent magnet, the relay coil generates an internal voltage opposing this increasing magnetic force. Graph (23) illustrates this; coil current declines rapidly as the contacts make (17) and it takes an exceptionally long time for the armature to travel the tiny distance from make (17) to seat (18). Falling coil current and bending of leaf spring (20) occur together, bringing the armature to a complete stop. The stop is followed by another current rise increasing the magnetic force until it overcomes the additional spring tension. It eventually begins to move again as indicated by the second occurrence of falling current. Unfortunately until the armature seats (18) bending leaf spring (20), pressure between the contacts is low.

This long delay in developing contact pressure is problematic. Electricity is of course not waiting for the contacts to develop full pressure, it flows the instant they touch. With light contact pressure the relay cannot handle its rated current and certainly cannot handle inrush currents. Low pressure increases contact resistance allowing the current to pit or weld the contacts. Light contact pressure also prolongs contact bounce. Bounce occurs as hard contacts slam together and ricochet off each other numerous times before maintaining firm continuous contact. Thereby a single contact closure becomes in reality a dozen or so rapidly occurring on-off cycles. Bounce in a signal wire is awkward, but with a high current load, it is a disaster. Heavy pitting occurs because the contacts have a tiny bouncing gap between them while high voltages and currents are present. They also make a dozen electrical contacts for each mechanical operation and wear quicker.

These naturally occurring electromechanical properties are just not good for closing electrical contacts. What is needed is a snap type action, present in most ordinary switches, where once the contacts begin moving they steadily accelerate until they seat. A relay's natural properties provide just the opposite: a sudden stop just as the contacts touch followed by a long bouncing hesitation. Graph (23) also reveals some temperature problems; Hot the relay exhibits a longer make (17) to seat (18) hesitation, further delaying the application of full contact pressure. When cold the relay seats faster but its current drops are sharper producing more contact bounce. Coil temperature changes with ambient conditions but it changes quickly as current flows thru its frame, contacts and coil. In seconds the relay can have a 60° C. temperature rise. Furthermore relay timing from excitation at time zero to make (17) changes drastically with temperature.

Coil current varies widely in graph (23) but its voltage does not change after time zero and if shown would simply be a fixed straight horizontal line. Coil voltage remains the same for any temperature, coil resistance, relay movement, or current. This fixed voltage should then be equal to the sum of the relays dynamically generated internal voltages and voltage losses. The inventor has developed the following formula and suggests that it describes the dynamic electrical properties of standard relays. The voltage across the coil is (E) while the instantaneous coil current in graph (23) is (i).

$$E = L \frac{d i}{d {t}_{1}} + i \frac{d L}{d {t}_{2}} + i R$$

The first term, inductance (L) times the change in current (di/dt), is recognizable as the back-emf generated by an inductor. The di/dt unit is the amp/second or more conveniently ma/ms. Relay inductance produces (di/dt), and this is the relay's method of controlling its own current, continuously varying it to balance the equation. When external voltage (E) is applied di/dt becomes active, controlling the rate of change of (i), its instantaneous current. When di/dt is positive the relay is balancing the equation by forcing an increase in current and when di/dt is negative it is balancing the equation by forcing the current to fall. An example of this terms unusual efficiency occurs when (i) is zero making all other terms zero, and (L di/dt) generates a voltage equal to the externally applied voltage (E) or (22) in FIG. 2. This is true regardless of the magnitude of the external voltage (22), the speed of switch (21), or the relays inductance (L). Giving di/dt the unique ability to be both infinitely efficient and infinitely fast. Making dynamic coil current unusually hard to control.

Another internal voltage is generated by the relays mechanical motion, which in the formula is the current (i) times its changing inductance (dL/dt). Inductance changes when the relays armature closes or opens its magnetic path. The dL/dt unit is the henry/second or more conveniently mh/ms. While the armature is closing, rising inductance (dL) generates a positive voltage and conversely as it opens, decreasing inductance generates a negative voltage. It is only generated while the armature is in motion and while stationary dL/dt is zero. A closing armatures positive dL/dt voltage unbalances the equation, forcing di/dt to respond by going negative, lowering instantaneous current. The dL/dt effect is not linear and peaks at a most inopportune moment, just as the contacts touch. Lowering the ampere-turns and force on the armature just when it is needed to apply pressure between the contacts.

The last term of the equation (iR), is the voltage lost due to the relay coils wire resistance (R). Coil resistance is designed to be very high, since with a fixed voltage it must also serve as a means of limiting coil current. Thereby resistance plays a far larger part in relay timing and coil heating than normal. Coil heat, frame current, and contact heat all produce fast coil resistance changes that are also highly nonlinear, +4400 ppm/c to +2800 ppm/c, depending on the ambient starting temperature. Making coil resistance hard to predict. Whenever relay induced di/dt balances the equation it includes the (iR) term such that wire resistance significantly affects how fast the coil current rises or falls. Varying the relays magnetic vectors, and timing with temperature.

Opening relay contacts produces problems similar to those encountered when closing them. Releasing (FIG. 2) switch (21) disconnects relay coil (6) and rapidly falling di/dt produces thousands of volts, necessitating some sort of reverse voltage clamping. Clamping limits coil voltage to some value of negative (E). With (E) limited, relay (L di/dt) takes control of current varying it with the coil resistance (iR). Drastically changing the break timing with temperature. More importantly when the relay armature moves open, it generates so much negative (i dL/dt) voltage that di/dt rises to rebalance the formula. Increasing the coil current at a most inopportune moment; just before the contacts break in FIG. 1 at (17) and while leaf spring tension (20) is low. Causing a delay in armature movement while there is low pressure between made contacts. Worst case contact break hesitation occurs when a reverse protection diode is connected across the relay coil, clamping its voltage at −0.6-volts. Maintaining low pressure between the contacts for a very long time.

Closing the relay contacts at zero voltage and opening its contacts at zero current might normally be expected to extend the life of the relay. However the relays naturally occurring low contact pressure is so prolonged that damage occurs anyway. In addition prior zero crossing patent art using relay timing or timing with feedback correction is wrong most of the time. Here temperature creates the largest error. Set the timing for a cool relay and seconds later it self-heats 60°. If it is not allowed to cool then the next make operation is off by 60°. When feedback correction resets the timing for the hotter coil, it is 60° wrong if it is allowed to cool. Last use cannot predict a relays future temperature and temperature is the main factor in relay timing. In addition the relays solid iron frame holds residual magnetism for a long time. This is reflected as instantaneous coil current the moment voltage is applied. Operating the relay a second after its last use, or an hour after its last use, results in different coil start currents, creating large timing differences. Last use cannot predict a relays future magnetic charge and magnetic charge is the second main factor in relay timing.

Just driving a pc-relay with standard electronic circuitry can destroy it. Motor loads draw high inrush currents that cause a drop in power-line voltage. Sometimes noticeable when lights flicker or dim as a motor turns on. However this also reduces power to the relay coil, just as its contacts make and before they can seat. It can be seen in FIG. 6, that when relay contact (40B) makes, an inrush or shorted load (7) does not just cause a power-line drop, it also reduces power to the relay's supply (22A). Loss of coil voltage extends low contact pressure and this alone during an inrush will damage a relay. Electronics compounds this by sensing the power loss early, resetting its logic and the relay. Assuring that all contact pressure is lost. When the contacts open, the inrush stops, power is restored, and the contacts can re-close causing another power loss. This cyclical on-off action produces a buzz that quickly destroys contacts. Electronic 100-ms power-up delays just change the buzz to 10-Hz and ultimately no timer solves this problem. In addition, the small size of the relay creates electronic problems for circuitry.

Small size raises capacitance between the relays high and low voltage surfaces. Capacitance allows electricity to conduct wirelessly from the power-line to nearby objects and the relay coil is nearby. There is no substitute for lots of space here; any insulation separating the relay coil from the relay contacts just increases capacitance. An I.E.E.E. C37.90.1, relay test specification, suggests that power-line noise is a bunch of high voltage spikes having 0.8-volt per picosecond rise-times. With minimal effort the high voltage aspect of this noise can be clamped but that does not change its rise-time. Each picofarad (pf) of capacitance wirelessly couples 0.8-amps of this noise, such that 20-pf produces a monster 16-amp spike in the coil. Its duration is so short that actual damage to coil connected components does not occur often. However it does tend to toggle transistors, usually at just 0.6 v, due to their internal capacitance. Furthermore connecting a coil pin to an ungrounded supply rail conducts this noise throughout the circuitry. All electronics based on the transistor like integrated circuits and power regulators are susceptible. Memory, storage registers, and microcontrollers, remember the noise long after it is gone such that erratic relay operation or a reboot may be required. It is not a coincidence that when a relay is used with a motor load it produces the same noise indicated by the I.E.E.E. test specification. Except that the source of the noise is much closer, directly at the relays contacts.

Ignoring mechanical configurations there are two electrically different types of relays; those with isolated frames and those with live frames. The live frame relay has another significant hidden problem. In FIG. 1 a live frame relay carries power line current (1) thru its fixed contact (2), to its moving contact (3) to a conductive leaf spring (20) that is electrically connected to an iron armature (4). The iron parts of the relay have a highly conductive coating thereby when the relay seats (18) two electrical paths lead to its load pin (7). Clockwise (CW) current path (8) travels thru the coil's iron core and frame to the load pin and counter clockwise (CCW) current path (9) passes across bent spring (19) to the load pin. Both frame currents produce a magnetic force (10) that is rotated 90° from the relay coil's magnetic force (12). Since path (8) is thicker, traveling thru the coil's center and much of the frame, its magnetic vector dominates as their sum. Thereby the coil magnetic vector (12) is pivoted by frame magnetic vector (10). Positive frame current pivots the magnetic pole toward (11) and when negative, it pivots toward (13). Both directions reduce the magnetic force holding the relays armature.

The magnitude of this effect is significant. As an example, frame current has just 1-turn, but at 80-amps produces an 80-iT magnetic vector (10). This sums with the coil magnetic vector (12) of 200-iT. Pivoting the magnetic field 22° away from the armature (11). In addition this pivoting magnetic pole induces AC into the relay's coil. Unfortunately the live frame relay also acts much like a current transformer. With high enough frame currents the combination of a pivoting magnetic vector and the oscillating relay coil current causes the armature and contact to vibrate. Quickly destroying the contacts with a high current buzz. This effect is prevalent during a locked rotor, surge, or short circuit. A pity because without this effect the live frame relay could easily handle short circuit currents without damage. This transformer effect also magnetically couples line and load noise currents into the relay coil. Producing large amounts of randomly polarized coil voltages and currents.

Isolated frame relays (14) avoid these problems, but have major size/rating and cost disadvantages. Its armature uses an insulated link (15) to move the contact allowing the frame to electrically float. Power-line current just flows thru the relay's contacts thereby it does not have any frame current and does not act like a current transformer. Typically its surge current rating is higher than the live frame relay. However lacking its thick current path (8), it carries less continuous current and the added complexity drastically increases its price. Other isolated frame relays, like the contactor, use its insulated link to move a 2-contact bridge. Making a heavy electrical connection across two unmovable contacts. However doubling the number of contacts also doubles the amount of force necessary to carry a particular current. Isolated frame relays tend to be either larger than, or carry less current than, live frame relays.

### BRIEF SUMMARY OF THE INVENTION

Relay contacts operate with a snap action when disclosed electronic waveforms, profile its coil current. Snap action reduces the prolonged low pressure that damages relay contacts. This means of driving the relay coil also reverses the properties of its voltage and current. Coil voltage now varies with movement of its armature, frame current, coil resistance, back-EMF, and temperature. Coil current follows a profile that is stable and independent of these changing electrical, mechanical, and environmental factors. Since coil voltage has no direct magnetic or mechanical effect its changes do not affect relay operation. However the relays new stable current profile has a dramatic affect. It moves, makes, breaks and seats predictably, regardless of its temperature, residual magnetism, or mechanical wear. Power-line synchronization means takes advantage of this new stability, concentrating on the position and pressure of the contact. The contact starts to move closed after the peak power-line voltage and makes at zero voltage. Full contact pressure is maintained until load-current is near zero and contact break occurs before zero current. Several types of coil current profiles are disclosed along with analog and software controlled embodiments. New relay friendly electronic reset logic is disclosed to maintain contact pressure during power losses caused by load-surge and load-shorts. Zero crossing and power-line voltage are combined with logic that does not disable but delays relay operation. Relay contact to coil noise problems are disclosed along with suppression techniques to stop electronic circuitry induced contact chatter. Diagnostic techniques and production methods are disclosed for relays that are sealed inside an enclosure. Automatic and manual timing adjustment means are also disclosed.

### BRIEF DESCRIPTION OF THE DRAWINGS

FIG. 1 mechanically details prior art and the relay operation in three stages, fully open contacts, when the contacts first touch and a fully seated armature with closed contacts. It also details the differences between a live frame relay and an isolated frame relay. Showing their contact and frame currents.

FIG. 2 electrically details prior art and its coil current verses time.

FIG. 3 electrically details an aspect of the invention, its coil current verses time, and coil voltage verses time, for the make cycle.

FIG. 4 depicts both mechanically and electrically the inventive make and break power line synchronization goals.

FIG. 5 shows adjustment coil current verses time graphs for three make ramp, and three break ramps.

FIG. 6 Micro controller embodiment of the invention.

FIG. 7 Discrete component embodiment of the invention.

### DETAILED DESCRIPTION OF THE INVENTION

Wrestling current control away from the PC-relay coil solves much of its operational problems and tightly controls its timing. This is made difficult by the relays tendency to control its own current. A simple current/voltage source switched into the coil at time zero cannot produce current for a long time. Defeated by the relay coil's infinitely efficient (di/dt) rebalancing of the equation. Such rebalancing will include (iR) temperature problems and (dL/dt) armature movement problems. The inventive means therefore controls both (di/dt) and (i). Since it is impossible to solve the relays operational problems after it finishes operating, the invention regulates (di/dt) and (i) beginning at time zero.

FIG. 3 illustrates the inventive system; Pressing switch (21) at time zero starts ramp (24) which profiles the current coming from the output of an externally controlled current source (25). The preferred embodiment's have a current controlled current source (current mirror) and profile signals that start and end with a linear ramp. A current source powers relay coil (6) regulating its current by varying voltage from the supply (22). The ramping control (24) sets (di/dt) by controlling the rate of change of (i), the instantaneous current. If the ramp starts at zero, the current source starts at zero current, initially making coil voltage (E) in formula-0012, automatically equal to (L di/dt). This is shown in coil voltage Graph-27 at time zero. It is automatic because the only coil voltage that will produce zero current rising at a ramp rate of di/dt in a coil with inductance (L) is a voltage of (L di/dt). The inventive system provides this exact voltage regardless of the coils inductance (L) at that moment. Balancing the formula with (E) and fixing the value of di/dt. Thereby stopping relay coil di/dt from taking control of its own current.

Balancing the equation by varying (E) also stops relay di/dt from taking control as the other terms of the equation change. As the instantaneous current (i) rises above zero, coil wire resistance voltage drop (iR) attempts to reduce the current. The current source instantly reacts to this, automatically providing a coil voltage of exactly (L di/dt+iR). This is automatic, regardless of the wire resistance R, because only a voltage of exactly (L di/dt+iR) will allow the current source to reach its instantaneous set point current of (i) that changes at a ramp rate (24) of di/dt in a coil with an inductance of (L). Balancing the formula with (E) and stopping wire resistance (R) from changing the relays current. This is shown in coil voltage Graph-27 after time zero to move (16) as a steadily increasing non-linear voltage that changes with (iR) and temperature. Its effect on coil current is shown in Graph-26 after time zero to move (16) as a linear rising current (i) that is independent of temperature.

The preferred embodiment holds the ramp at a coil current that causes the relay armature to move (16) at a fixed point in time, and at a desired speed. Setting di/dt to zero and reducing the voltage requirements by (L di/dt), saving a few volts. This is seen as a sizable dip in coil voltage in Graph-27 and as a fixed non-changing current in Graph-26. As the relay armature accelerates to make (17) it begins to generate a rather large positive voltage from its movement. This attempts to reduce the instantaneous current (i) as sensed by the controlled current source. Automatically providing a new coil voltage (E) of exactly (L di/dt+i dL/dt+iR) on a continuous basis. A continuously changing (E) is needed to maintain the coil current during the movement voltages sharp peak. Thereby rebalancing the formula with (E), and stopping relay di/dt from taking control of its own current.

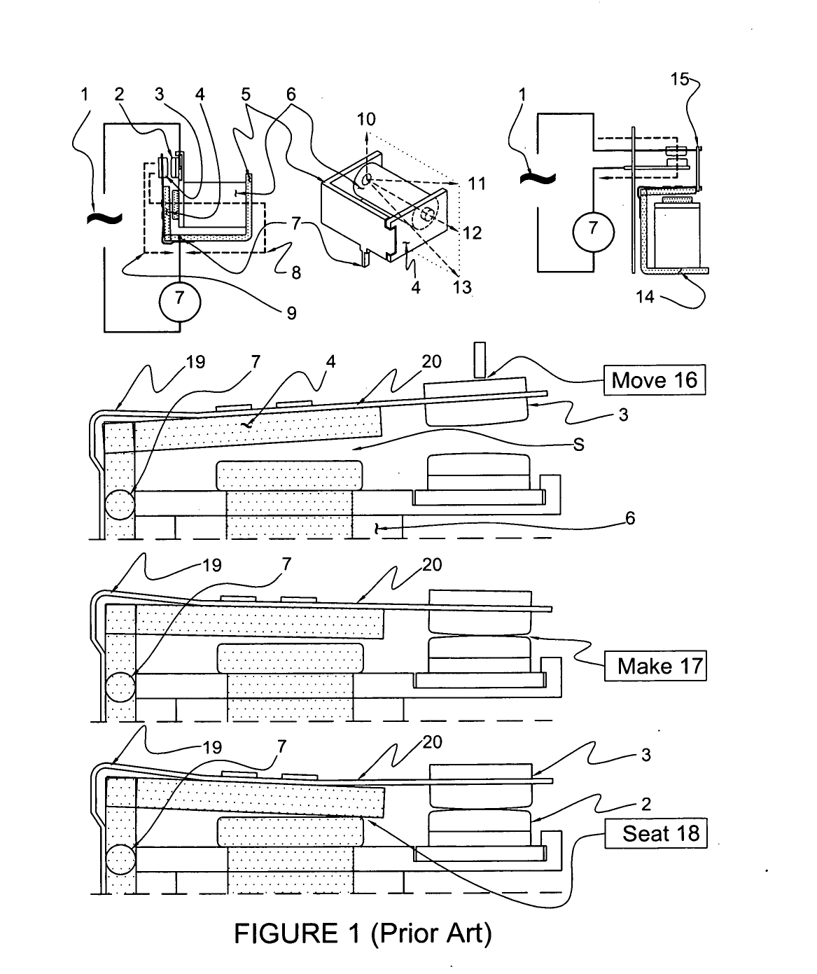

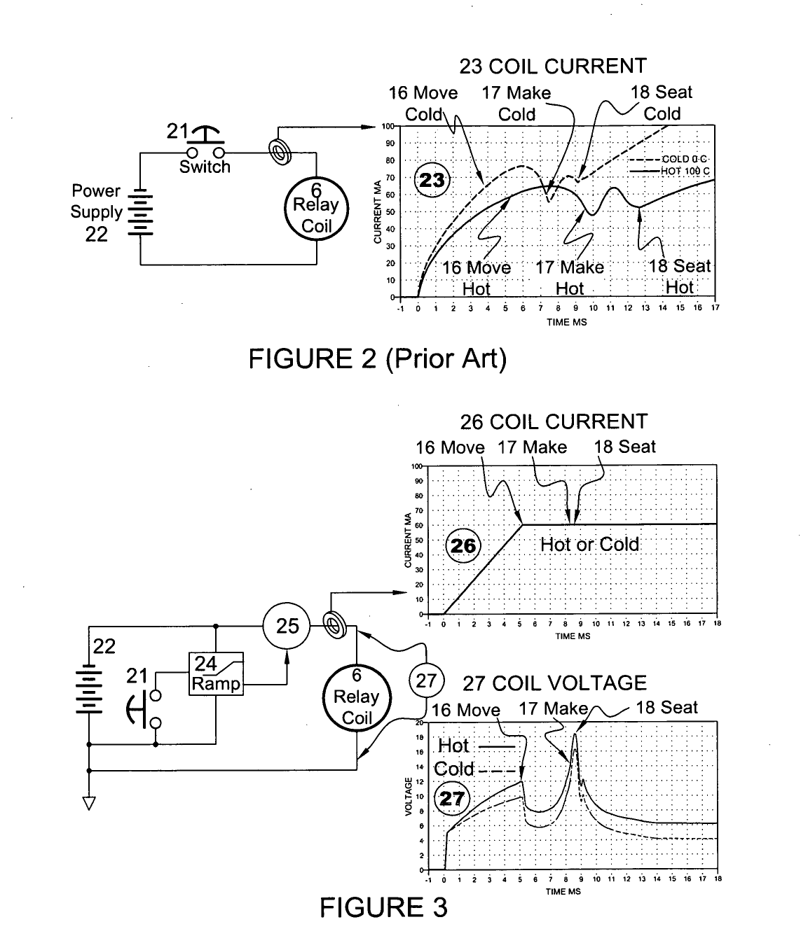

This process reverses the coils characteristic current and voltage graphs. The current Graph-26 is now linear, stable, and independent of temperature or armature movement. The voltage Graph-27 varies with resistance, current, temperature and movement of the armature. Since coil voltage has no direct magnetic or mechanical effect its variability does not affect relay operation. However the relays new stable current profile has a dramatic affect on relay operation. Hot or cold the relay takes the same amount of time to move, make and seat. As the relay armature moves its magnetic gap gets smaller and the force attracting the armature increases. Like a permanent magnet when a steel bar gets close, the force between them increases. Since coil current does not drop, the armature is subject to an ever increasing magnetic force resulting in a snap action. Acceleration bends back moving contact (3) in FIG. 1 as the contacts make (17) due to its mass at the end of flexible leaf spring (20). The relay makes (17) and seats (18) nearly at the same moment. Within half a millisecond of contact, full pressure is applied. Full pressure reduces the amount of contact bounce and allows contacts to handle large surge currents.

During relay make the combination of armature movement and iR nearly doubles the coil voltage requirements for a critical instant FIG. 3, Graph-27 as it seats (18). Care must be exercised to insure that there is enough supply voltage or armature torque will fall. It is not the same when opening the contacts, since it is impossible to run out of voltage when coil current is decreasing rapidly. Releasing switch (21) in FIG. 3, signals ramp (24) to fall, setting −di/dt coming from the output of current source (25). Automatically making the coil voltage equal to the finite value of (L−di/dt+iR) resulting in a reasonable voltage. Only this voltage will allow the current source to reach its instantaneous set point current of (i) that falls at the ramps rate (24) of −di/dt. Balancing the formula with (E) and stopping coil di/dt from taking control of its own current. The coil will likely reverse polarity such that its voltage will be negative and it is important to allow this reversal without clamping.

Falling coil current reduces the magnetic force (F) on the armature until it becomes less than the tension of the relay's two springs and it starts moving open. This begins when the coil current (i) ramps down very low, due to the high force (F), (equation 0005), produced by a tiny seated magnetic gap distance (S). Thereby a low instantaneous current (i) accompanies the break in the relays magnetic path. Producing a very reasonable negative (i dL/dt) voltage as the armature moves open. The inventive system offsets the negative movement voltage with a corresponding drop in coil voltage (E), stopping any rise in coil current. Coil current continues to fall to zero at the rate set by ramp (24). Coil voltage varies widely during this process but voltage has no direct mechanical effect on the relay. Declining coil magnetism and an increasing gap distance (S) rapidly reduce the force (F) on the armature to zero. Allowing it to snap open under the accelerating force of its own springs.

The inventive system of ramping coil current control vastly improves relay reliability by providing a snap action make and break. It also cures surge current problems in live frame relays by maintaining coil current vectors while frame current vectors are oscillating. Its dynamic motion is the equal of other snap acting switches and its static power handling ability far exceeds them. The relay still cannot mash together worn contacts or break apart stuck contacts like an industrial contactor. However its low mass armature can be operated at a far higher speed. Not as fast as a solid state switch but certainly much faster than the AC power-line. A byproduct of the inventive current control system is high accuracy, temperature stable relay timing. Combining high speed, snap action, stable timing and power-line synchronization can prevent contact damage and sticking from occurring in the first place. Removing the necessity for the hammer like action of a contactor.

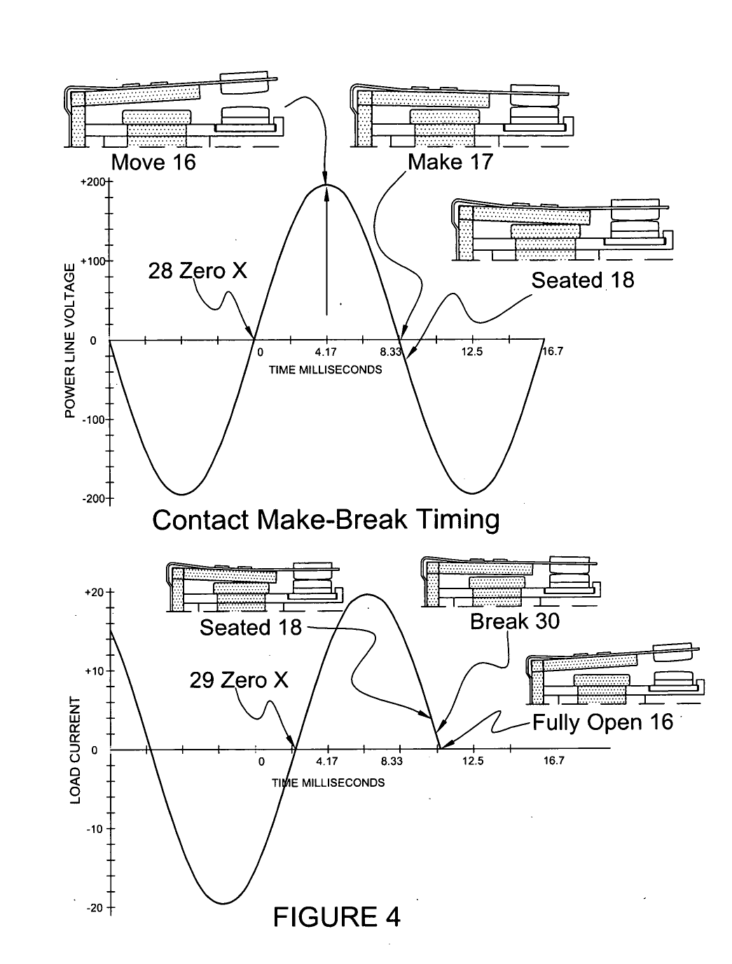

The inventive power-line synchronization objectives are illustrated in FIG. 4. It can be seen that if the contact begins to move (16) before the peak power-line voltage and was partially closed at the peak voltage, arcing might occur. Furthermore the arc will not quench until the contacts touch and the melted area can stick. The pc-relay has little force to break apart such stuck contacts. The inventions goal is to cause the relay contact to begin moving at or soon after the peak of the power-line voltage and to make at zero voltage. Break objectives are different and a bit more complex since open contacts alone cannot disconnect an inductive load such as a motor. Here a motor acts just like the inductor in an arc-welder. Welders use low voltage (about 15-volts) but contain an inductor that stores magnetic energy when an electrode contacts the weld. As the electrode disconnects from the weld the stored magnetism strikes a low-voltage (below 15-volts), high-frequency arc, that does not quench until the electrode pulls quite far away. Similarly, closed contacts store magnetism in the motor and strike a high frequency arc as the contacts separate.

Pc-relays and even contactors do not have enough contact separation to quench a motor induced arc once it is struck. The arc conducts nearly full current into the load across fully open contacts until the next zero current point. When contacts separate a smidge past zero current, the struck arc builds to peak current and continues throughout the entire half cycle. Thereby a zero current contact opening that is slightly late produces the largest and longest lasting arc. Furthermore zero current (29) does not mean that there is zero energy in a motor; it is still spinning and generating a very high voltage. Zero current means the voltage, generated by the motor, happens to equal the power-line voltage at that moment. Motor and power-line voltage cross, at high but equal voltages, and when disconnected quickly head in opposite directions. Relay contact separation, by comparison, is slow and high voltage across barely separated contacts strikes an arc, even at perfect zero current. Sustaining conduction into and thru the next half-cycle.

Attempting to break relay contacts at a perfect zero current point has another problem. Any one motor zero current crossing (29) cannot accurately predict the next or any future zero current crossing point. Up to half a revolution of shaft rotation occurs between zero current crossing points. Pulsating loads like air or refrigerant compressors, and some pumps or blowers load the motor during part of a revolution and unload it at other parts. Ultimately introducing significant jitter into the phase angle of each zero current crossing. The closer relay contacts come to breaking at a predicted zero current point, the higher the risk of breaking late. Producing larger arcs more frequently than might be had by just randomly breaking the contacts. It is the inventions intent per FIG. 4 to break (30) the contacts before zero current, and to have them fully open (16) at zero current. This sometimes produces an arc but guarantees that it has low current and a short duration. Solid state switches, such as triacs, do the same thing; they disconnect the load at their holding current, before zero current.

Despite the inordinate amount of attention it gets, relay arcing, by itself, has little effect on cold contacts. Damage actually starts after the contacts start opening (18) and just before they break (30). During this interval falling contact pressure introduces a period of high contact resistance on a microscopic area of the contact. This heats with current, time, and resistance, per (P=i²Rt). Melting a pinpoint sized dot between the contacts. As they separate, arcing vaporizes the molten area spewing out contact material, and leaving behind oxidized craters. Without the arc, damage still occurs, a tiny lump follows one contact and a matching pit is left in the other. It can be seen FIG. 4 that un-seating the armature too early, raises contact resistance (R) while the current (i²) is high, exponentially increasing the heating effect (P). It is the inventions goal to keep the relay fully seated (18) until it is as close to the zero current point as possible. Maintaining the critical contact pressure until the current is too low to do any damage.

The stated goals of power-line synchronization strongly suggest that the relays start of movement timing is more important than its zero crossing timing. Badly timed starts lead to melted or stuck contacts, and relay failure, while a zero crossing error just causes additional wear. Blindly varying the relays start time to meet a desired zero crossing point is thereby particularly unwise. To do both the relay must hit two targets that are a fixed time apart. For example, in FIG. 4, move (16) at or after peak voltage is the first target, and make (17) at zero voltage is the second target, and they are (dt₂) apart. To be in the inventions target area all relays must have an armature travel time, of less than (dt₂). If the travel time is greater than (dt₂) one of the targets will be missed. In relay contact make, maximum (dt₂) time at 60-Hz is 4.17 ms and at 50-Hz its 5 ms. Faster speeds have the advantage of working for both frequencies.

Faster relay make has some practical limitations in that the relay must be capable of producing such speed and requires more current to do so. Raising the coil current (i), increases the force on the armature, resulting in a shorter travel time (dt₂) and requires a higher (i dL/dt₂) movement voltage. Thereby make speed is limited by the power supplies current and voltage. Relay break has no current or voltage limitations since its current is falling toward zero and any required voltage is being generated by the coil. Break acceleration can be almost as fast as its mass and spring force allow. Shorter break times (dt₂) produce higher negative movement (i−dL/dt₂) voltage and higher negative ramp (L−di/dt) voltage. Thereby break speed is only limited by the voltage rating of the current source. This voltage is controlled in the invention by the break ramp rate, since any attempt at coil voltage clamping introduces temperature and movement errors. It can be seen in FIG. 4 that break speed from seated (18) to fully open (16) is very fast, and far faster than make speed. Allowing the load current to be very low before releasing the pressure between the closed contacts.

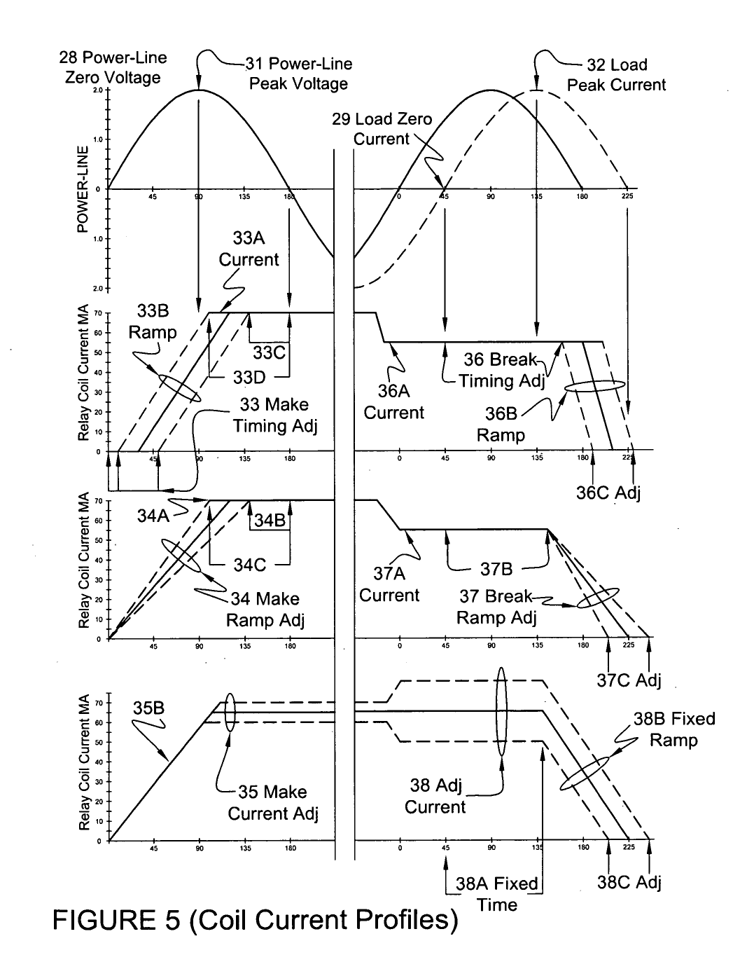

Each relay has a slightly different timing. Leaf spring (20) is not always as flat as FIG. 1 might suggest. Causing each relays fully open (16) magnetic gap distance (S) to be slightly different. In addition it's fully seated (18) armature to coil alignment is not perfect. Causing each relays fully seated (18) magnetic gap distance (S) to be slightly different. Small gap (S) differences change the force produced on an armature by a factor of (1/S²) causing a much larger variation in relay to relay timing. At a fixed current, smaller fully open (16) magnetic gap distances deliver more force to the armature, closing it faster. Better seated (18) armature to coil alignment produces more force on the armature, opening it at a lower coil current. Thereby some initial adjustment of make and break is necessary for individual relays. The inventions ramp-up to make, ramp-down to break and coil current control leads to several new means of performing this adjustment. Three of these are illustrated in FIG. 5; timing adjustment, ramp speed adjustment and current adjustment. Changing any one or several of these will vary the relays timing. Since it is simpler to have just one adjustment, two out of the three factors are fixed.

In all FIG. 5 profiles, ramp-up stops sometime after the peak of the power-line voltage (31) and ramp-down starts sometime after the peak of the load-current (32). Relay-make movement is in sync with the peak of the power-line voltage and relay-break movement with the peak load-current. Thereby avoiding destructive dynamic starting points while still allowing ample zero crossing adjustments. During relay-break, coil current may reach zero before the load-current does (36C-37C-38C). Giving the relay time to un-seat, break and travel to its fully open position at zero load-current. Timing adjustments (33) delay the make ramp until sometime after zero voltage. It has a fixed final make coil current (33A) and a fixed ramp rate (33B). The delay adjustment allows relays that move faster (33C) than others (33D) to all make at zero voltage. Similarly break timing (36) delays the ramp-down until sometime after peak load current. It has a fixed starting coil current (36A) and a fixed ramp rate (36B) thereby allowing relays that open faster (36C) than others to all break sometime before zero load current.

Ramp rate adjustments also compensate for different relay gaps. Make (34) ramps all start at the same time conveniently shown at zero voltage. It has a fixed final make coil current (34A) and an adjustable ramp rate. The adjustment allows relays that move faster (34B) than others (34C) to make at zero voltage. Similarly break (37) ramps all start some fixed time after peak load current (37B). It has a fixed starting coil current (37A) and an adjustable ramp-down rate thereby allowing relays that open faster (37C) than others to break sometime before zero load current. The next set of graphs use coil current adjustments to equalize the force across different gaps. Make (35) ramp starts at a fixed time, conveniently shown as zero voltage. It has a fixed ramp rate (35B) and adjustable final coil current. The adjustment allows relays with larger gaps than others to get more current and still make at zero voltage. Similarly break (38) ramp-down starts at some fixed time after peak load current (38A). It has a fixed ramp-down rate (38B) and an adjustable starting current thereby allowing relays that open faster (38C) than others to break sometime before zero load current.

The issue of load inrush power loss and electronics is important since just one instance of this destroys the relay. It is avoided by using a large storage capacitor, or similar means to maintain power to the relay and circuitry during a power loss. Standard electronic reset logic is either removed or overridden. Instead resets are linked with the relays condition (on-off) and the level of charge on the storage means. Electronic resets occur whenever;

The relay is on, and the storage charge falls too low, or

The relay is off, and the storage is not fully charged.

The first eventually leads to the second. When the relay is on and power is lost the storage slowly discharges until eventually it runs low on energy and the logic is reset, turning the relay off. Preferably this should be longer than the few seconds it takes to trip a circuit breaker, but it must always be longer than the loads inrush current. The current source helps by reducing the discharge rate and regulating relay coil current as supply voltage falls. Preserving full contact pressure without the need for external power. When the relay is off, reset logic stops its operation until there is enough stored energy to drive it and keep it seated.

The problem of power-line noise affecting relay connected electronics is resolved by grounding one of the coil pins. However the correct pin must be chosen, especially in the live frame relay. Noise is coupled stronger into windings that are in the first layer of the bobbin, those closest to the relays iron core. Grounding this end of the coil stops noise from reaching windings that are further away. Grounding the top bobbin winding layer cannot reduce the noise due to the coils high impedance. Thereby, from a noise control standpoint, the relay coil has a definite polarity. Ground does not necessarily mean a power-line ground wire, since it's far too long to control noise. Ground refers to a ground plane, large conductive surface, or conductive enclosure that surrounds and shares as much capacitance as possible with the circuitry. The noise control plan sinks the correct coil pin into the ground plane. Since the coil pin, ground plane and connecting circuitry change together with the noise, relative to each other there is no difference. Thus the noise has no effect. However, due to the magnitude and fast rise-time of the noise, it also means that the relay cannot have any kind or type of electronic component between one coil pin and ground. Thereby limiting to some extent its connection options.

With a dedicated or known load relay break does not necessarily require zero current detection. Zero voltage and a fixed delay to compensate for current lag, if any, may be used instead. Saving some significant space and cost. This method breaks the contacts well after peak load current and sometime before zero load-current. A resistor-capacitor snubber (40C) can be used to lower the break rise-time and high frequency arcs. A surge suppressor (40D) clamps the high voltage spike that often occurs when an arc is absent. However when the load type is either unknown or has current lags that vary widely then some form of zero current detection is necessary. These take the form of magnetic detectors, current transformers, or pulse cores that have one side isolated from the power-line. They are usually small, suffer from the same capacitive coupling noise issues as the relay coil and should share the ground plane with the relay coil. There are also times when a load may be unplugged, just too small to detect, tripped a thermal overload, has burned out, or is just not connected. Such that after a relay-off signal occurs, the absence of a zero current signal should not stop it from going off.

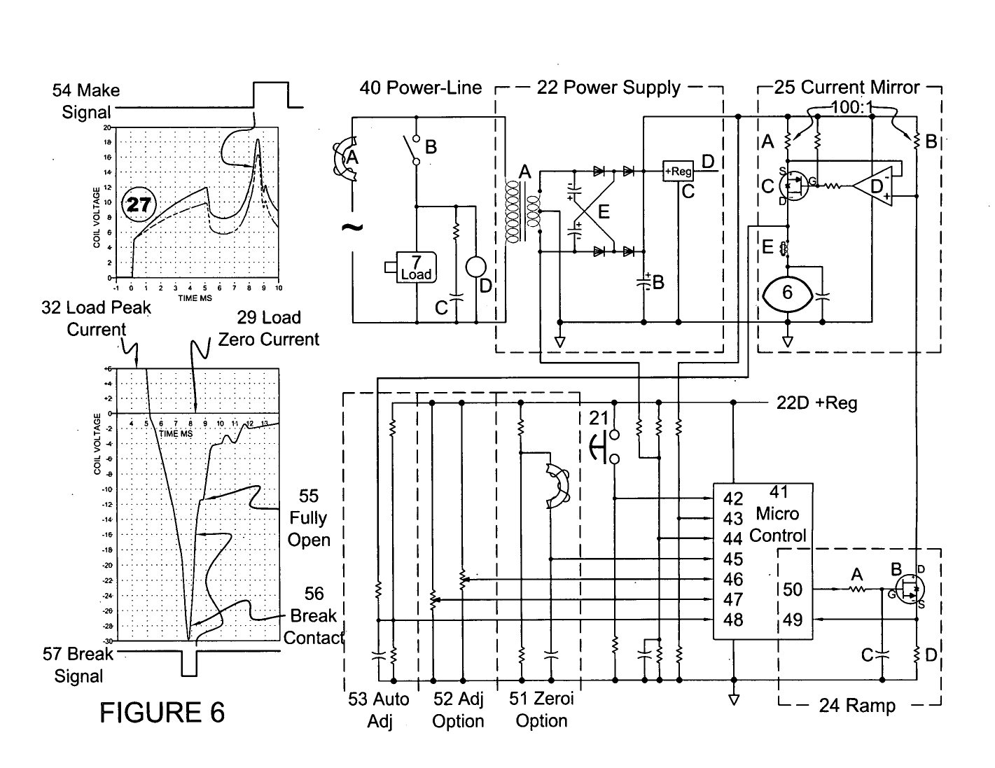

In FIG. 6 relay coil (6) has its correct pin grounded for power-line coupling spikes and a capacitor-choke filter (25E) to reduce any remaining noise. It should also be noted that when relay contact (40B) operates its contact noise conducts directly into the primary of transformer (22A). Thereby the transformer shares the relays power-line coupling problems and ultimately the same solution is used for both. In this case, the relay coil shares the ground plane with the transformers center-tap. Power supply (22) has an unregulated higher voltage across a large storage capacitor (22B) and a lower voltage regulated output for circuitry. Storage capacitor (22B) is driven by a non-active current source (22E) providing up to 2.4-times transformer voltage. Current is set by boost capacitors at about (0.125EC=i) and with an 8-V transformer 100 uf capacitors deliver 100 ma. Optionally a switching regulator could be used to perform a similar function.

Current mirror (25) uses the higher voltage unregulated output to provide power to the relay coil (6). Its op-amp (25D) drives the gate of P-fet transistor (25C) until the voltages across resistor (25A) and input resistor (25B) are equal. Thereby when resistor (25A) is 5-ohm and input resistor (25B) is 500-ohms, a 1 ma input produces a 100 ma output, boosting input current 100-times. Resistor (25A) can only get current from the source-pin of P-fet (25C) since the P-fet gate floats and ultimately all resistor (25A) current comes from the P-fet drain-pin driving relay coil (6). Open drain design maintains regulation of current even when the relay coil's polarity swings negative, far below ground. The op-amp input range should include its positive supply rail to allow starting at zero input current and have a near zero phase shift at low frequencies to prevent oscillation. The transistor provides the high frequency voltage changes necessary to maintain coil current while the op-amp just needs to be able to follow the input voltage across (25B). Forming an accurate, temperature stable, current mirror that multiplies an external input current.

The microcontroller (41) logic embodiment of the invention depicted in FIG. 6 has several A-D inputs allowing it to interpret changing analog input voltage levels. For example, storage capacitor (22B) voltage level is monitored thru a resistor voltage divider on pin (43). Power-line voltage and its zero crossings are monitored by pin (44). Its AC swing is offset from ground and divided using three resistors. While the controller has (A-D) analog inputs, it does not have (D-A) analog outputs, to create an analog ramp. A proper (D-A) is expensive such that here the controller needs to be finessed into producing an accurate analog output. It does this by monitoring voltage (49) across resistor (24D) in a feedback loop. Digital output (50) pulse modulates resistor (24A), charging or discharging capacitor (24C) until the gate voltage on transistor (24B) correctly produces the desired voltage at (49).

Voltage across fixed resistor (24D) indicates its current, in this case also the source and drain current in N-fet transistor (24B). The N-fet open drain is the output, allowing it to regulate current at the much higher voltage of the current mirror input (25B). Producing regulated relay current in spite of the large voltage swings of the current mirror's power supply. It is best if the ramp starts and stops at 1, the least significant digital bit, instead of zero. In a 10-bit system with a 70 ma relay this represents less than 70 ua of coil current. Maintaining bias voltage on transistor gates, capacitors, op-amps, and regulating the relays residual magnetism. Many controllers have a programmable comparator that can do this without continuous software intervention. This is implemented with the comparator output at (50), its input at (49), and its reference set by a software generated number. Software counts up to a number at a preset rate forcing (49) to follow along by modulating (50). Such that the number corresponds to an instantaneous relay current (i) and its counting speed the ramp rate di/dt.

This software programmed relay current, ramp rate, and timing delay should result in a central relay adjustment profile. One of those shown in FIG. 5 or some combination of those ramps that mimics the perfect adjustment for most relays. Thereby most relays either do not require adjustment or require very little adjustment. As a practical matter with this invention adjustments never need to change unless the relay sustains some physical damage. Manual adjustments (52) using trim-pots are inconvenient but cannot loose their memory and are easily set without programming. They connect across the power supply rails and in their center position no adjustment occurs. Movement above or below center changes one of the profile parameters. Using this method trim-pot tolerance or temperature does not affect its output voltage as measured at pins (46 & 47).

Optionally automatic (53) adjustments are made by using coil voltage feedback. Automatic adjustment feeds the relay coil voltage back to pin (48). Its bi-polar swing shown in the graphs is offset from ground, divided using three resistors, and filtered with a capacitor. The direction of the voltage swing on pin (48) identifies whether it is a make or a break signal. A simple fixed voltage produces an edge signal the moment (54) its contacts make. A simple fixed negative voltage signals when its contacts open (57). This occurs after the negative coil voltage peaks (56) and sometime before (55) it returns to zero voltage. Software compares these make or break points with the zero crossings and generates an error number indicative of the magnitude of the discrepancy. The error number is used to correct one or more of the profile parameters until the error is zero. This may be done continuously but that would be unwise. Relay coils are noisy and this will eventually lead to wrong adjustments. Thereby it is best to operate the automatic system in a controlled environment and then lock in the resultant settings.

A relay-on signal (42), a fully charged storage capacitor (43), full AC power-line voltage (44), a zero crossing point (44), and software delay (if any) signal the controller (41) to start the make ramp. A relay-off signal (42), a zero current signal (45), and a software delay to sometime after peak current, signals the controller to start ramp-down. Once the relay operates, the storage voltage (43) is monitored. If it indicates less than (16 to 20-ms) of charge remain, the controller disregards the relay-on signal (42). It waits for a zero current signal (45), and a software delay to sometime after peak current, starting the ramp-down to turn the relay off. This occurs before the voltage regulator (22C) or controller (41) invokes its own built in version of electronic shutdown, destroying the relay.

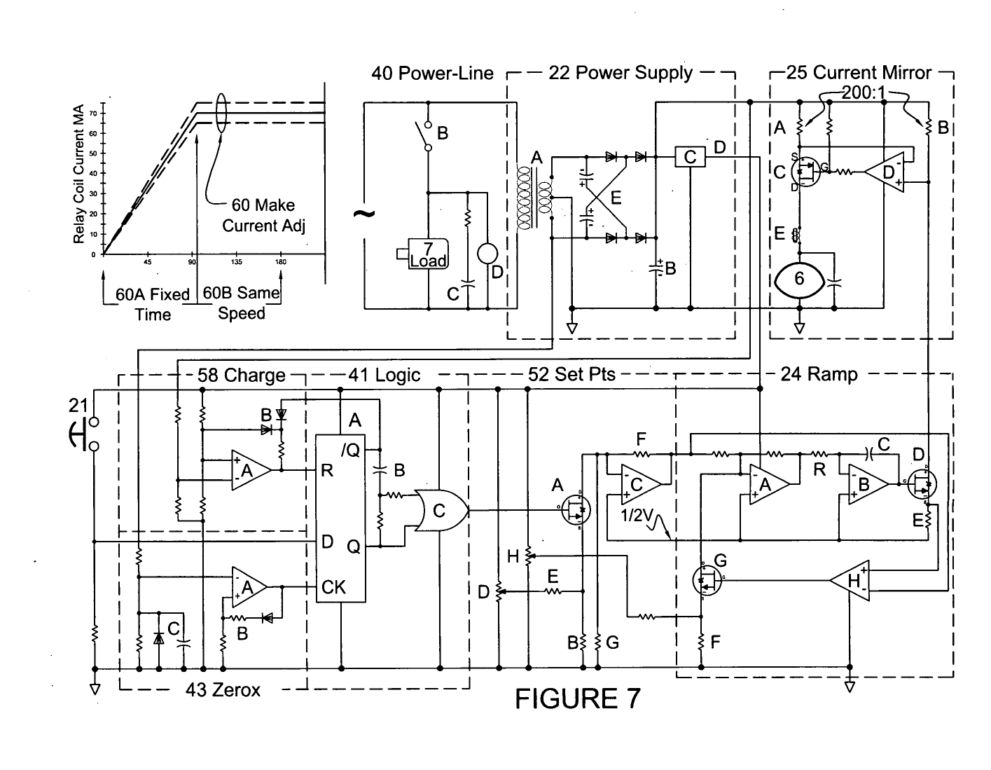

A functionally similar system using analog components and hardwired logic instead of a micro controller is depicted in FIG. 7. It uses more components and space but has the key advantages of lower cost, higher accuracy, no programming, and never needs a re-boot. When power is applied the voltage on storage capacitor (22B) is monitored by comparator (58A) thru a voltage divider on its (−) input. Its (+) input is held at the proportional equivalent of a fully charged capacitor by a voltage divider. When the storage capacitor is fully charged a low comparator output enables flip-flop (41A) thru its reset pin. Flip-flop (41A)/Q-high, stops comparator hysteresis thru diode (58B) anytime the relay is off, while /Q-low releases the hysteresis anytime the relay is on. Hysteresis stops an electronic reset until the voltage on storage capacitor (22B) falls below the relays minimum holding voltage.

Zero voltage and full power-line voltage are both detected by comparator (43A). Providing clock pulses to flip-flop (41A) at full line voltage and none at low line voltage. Transformer (22A) AC voltage passes thru a voltage divider and noise/polarity filter (43C) to the comparator (−) input pin. Comparator output is normally high, holding its (+) input at the proportional equivalent of near peak power-line voltage thru diode and resistor divider (43B). To trip the comparator output low, the power-line voltage on its (−) input must exceed it's (+) input set point voltage. Comparator low means the AC power-line hit a peak. A low output drags it's (+) input along thru (58B) setting it at zero. With the (+) input now at zero, the comparator output is ready to go high the moment the power-line and the (−) input falls to zero. Thereby to get a high going edge, requires peak power-line voltage followed by a zero crossing. Highly useful when several motor loads share the same power-line. When an external inrush drags down the power-line, clock pulses disappear until after it passes, usually in less than 0.2-seconds. Delaying relay operation for a moment and preventing heavy loads from randomly starting together.

Logic (41) consists of just a flip-flop and an or-gate. Highlighting how little digital logic is actually needed for this application. Closing switch (21) forces data high and the next clock latches Q-high, and /Q-low. Q-high instantly forces or-gate (41C) output high, regardless of /Q going low. Or-gate output high switches on analog circuitry that sets and adjusts the relay's make current (52). N-fet (52A) connects make resistor (52B) and make trim-pot (52D) to op-amp summing input (52C). Op-amp (52C) (+) input is biased at ½-v, and its summing input (−) current times 200, becomes the relay's final current. Make resistor (52B) produces the central profile current (60), on summing (−) input (52C), such that most relays do not require adjustment or require very little adjustment. When make trim-pot (52D) is centered, it produces ½-v, such that it does not modify op-amp (52C) input (−) current. Rotating the trim-pot creates a ± voltage difference from ½-v, which is converted into a limited ± input current by resistor (52E). Trimming the current about its central value. Resistor (52G) prevents absolute zero coil current, by slightly biasing the summing point (52C), ramp (24), current mirror (25), and relay (6) for instant response.

Op-amp (52C) output voltage is used by the ramping circuitry (24) as output current starting and stopping points. Comparator (24H) insures that the voltage from op-amp (52C) equals the voltage across (24E). When resistors (52F) and (24E) have the same resistance, equal voltages produce equal currents. In this case that also equals the drain and source current from N-fet (24D). The open-drain of the n-fet is the ramps (24) output current. When relay make signals op-amp (52C) output to jump to a higher voltage, comparator (24H) output is low until the voltage across resistor (24E) catches up. This rate is controlled by op-amp (24B) its feedback capacitor (C) and input resistor (R). Following the formula;

$$t = \frac{C R ( d v )}{{V}_{R}}$$

The voltage across input resistor (24R) is (V_{R}) and the change in op-amp (24B) output voltage is (dv). Circuitry converts formula (0063) into formula (0065) by setting (V_{R}) equal to (dv) allowing the terms to cancel out. Op-amp (24B) maintains some (+) voltage bias on N-fet gate (24D) such that the current thru resistor (24E) is never zero. Any increase in gate voltage above this bias point produces an equal increase in voltage across resistor (24E). Thereby when op-amp (52C) output jumps from a slight bias voltage to a higher make voltage, that output voltage jump is (dv). Op-amp (24A) simply inverts this voltage, usually with a gain of one, driving ramp input resistor (24R) with a voltage (V_{R}) of (−dv). Setting (V_{R}) equal to (−dv) and resulting in the fixed ramp time (tₛ) shown in formula (0065). Op-amp (24B) ramp time (tₛ) is independent of its input or output voltage;

tₛ=CR

Ramping always takes the same amount of time (tₛ). For example, with values of 51.1K and 0.1-uf the ramp rise time is fixed at 5.11-ms (60A), regardless of the starting or stopping current magnitudes. At 60-hz a half cycle occurs in 8.33-ms, and starting to move at 5.11-ms forces all relays to accelerate for 3.22-ms to make at zero voltage (60B). Adjusting coil current using trim-pot (52D) or even changing make resistor (52B) does not change (tₛ). Forcing all relays to make in the same amount of time (60B).

The break cycle starts by releasing switch (21). This forces data low and the next zero voltage clock latches Q-low, and /Q-high. A/Q-high drives capacitor (41B) which was charged to +V, to twice that, keeping the or-gate (41C) input and output high. Q-low discharges the capacitor thru a resistor and at about ½-v the or-gate output goes low. Delaying ramp-down until sometime after peak current has passed. Illustrating how a lag delay timer is used instead of a zero current detector. Or-gate (41C) low turns off N-fet (52A), disconnecting make resistor (52B), make trim-pot (52D), and instantly drops the current into op-amp (52C) to the minimum bias. Ramp comparator (24H) (−) input, detects this drop turning on N-fet (24G), connecting break resistor (24F), and break trim-pot (52H), to the summing node of op-amp (24A). Resistor (24F) produces an output voltage from op-amp (24A) that causes the ramp (24B) to fall at a rate mimicking the central break profile in FIG. 5 (37). Since the summing node of op-amp (24A) is at ½-v, when break trim-pot (52H) is centered at ½-v, it does not modify op-amp input current or output voltage. The ramp falls until the voltage across resistor (24E) equals the voltage across resistor (52F). Ramping comparator (24H) then pulse modulates to maintain the equal voltages.

Ramp profile embodiment (60) provides a means of establishing some reasonable level of control on relay defects. Fixed ramp time (60A) forces all relays to accelerate for a fixed time (60B). Furthermore identical relays, forced to accelerate for a fixed time, use the same amount of coil current to do so. Mechanical differences in the relays are thereby revealed by their deviation from the central coil current adjustment. Since mechanical defects are hard to see and visually hidden by the relays sealed enclosure this might be the only indication of a problem. A bowed leaf spring (20) of FIG. 1 does not change relay contact distance due to open stop (16), but does enlarge its magnetic gap (S). Increasing coil current requirements. A concave leaf spring (20) also does not change relay contact distance due to open stop (16), but reduces the magnetic gap (S). Lowering coil current requirements. Bowed springs can prevent the armature from seating and concave springs can prevent full contact pressure.

Other defects can be revealed by using the coil's voltage. Armature travel time (60B) is also dt₂ in the armature movement term (i dL/dt₂) of equation (0012). If (dt₂), (i), (R) and (dL) are fixed in value and (di/dt) is held at zero, then the equation can be simplified and combined with equation (0005). Resulting in just two variables, gap distance (S) verses coil voltage (Eₛ). Constant K in the example relay of FIG. 1 is (1×10⁻⁴) and does not change unless iron thickness, length, width, height, or permeability also changes. This special case also assumes that (dL), the relays seated inductance minus its fully open inductance, is fixed. Generally this varies with movement and without movement dL is zero and the assumption is wrong. However the purpose here is to reveal relay defects by comparison to what should happen in a perfect relay. So that their respective coil voltage waveforms can be compared as they operate.

$${E}_{s} = K \frac{i ( d L )}{{S}^{2} ( d {t}_{2} )} - i R$$

The formula predicts the coil voltage (Eₛ) at any particular gap distance (S) in the special case defined by (60) for a known good relay. Deviations denote a problem. Used in reverse it predicts the fully seated gap (S) when the relays peak voltage is measured. Example FIG. 1 relay, produces a peak of 11.2-v above iR, calculating its seated gap (S) yields 0.0078-inches, hard to measure manually. One of its advantages is that small gap (S) differences show up as extra large voltage changes (Eₛ) due to the (S²) term. Carbon, dust, dirt, rust, surface roughness, corrosion or misalignment increase (S) and show up as a lower peak voltage. Hairline cracks in the iron or a sprung armature lower (K) and (dL), also showing up as a lower peak voltage. Just monitoring the peak voltage alone reliably detects a host of relay problems. Ramp timing embodiment (60) allows this comparison to be routinely made in production. Picking out abnormalities that are not easily detected by other means.

Accordingly, there has been disclosed an improved relay drive method. While exemplary embodiments of this invention have been disclosed, it is understood that various modifications to the disclosed embodiments are possible, and it is intended that this invention be limited only by the scope of the claims.

I claim:

1. A relay control improvement comprising a means of varying the relay coil voltage such that coil current is proportional to an input signal, wherein;
the rate of change of said input signal controls the rate of change of the relay coil current;
the magnitude of said input signal controls the instantaneous relay coil current;
the waveform of said input signal represents a coil current profile.

2. The relay control according to claim-1, further comprising limiting the rate of change of the profile to limit the relay coil back-EMF voltage.

3. The relay control according to claim-1, further comprising profiles that contain linear ramps.

4. The relay control according to claim-1, further comprising programmable profiles.

5. The relay control according to claim-1, further comprising diagnostic means including;
controlling the make profile such that it rises to a desired magnitude and maintains a zero rate of change before the relay contacts make;
means of comparing coil voltage of the relay under test as its armature moves to a known working standard relay;

6. The relay control according to claim-1, further comprising a sealed enclosure filled with a dielectric gas.

7. The relay control according to claim-1, further comprising a profile synchronized with the AC power-line voltage or current.

8. The relay control according to claim-7, further comprising;
controlling the profile such that it does not allow the relay contact to start closing until at or after the peak AC power-line voltage;
controlling the profile such that it does not allow the relay armature to break its magnetic path until after peak load current and before zero load current.

9. The relay control according to claim-7, further comprising a profile that adjusts to accommodate differences in individual relays.

10. The relay control according to claim-9, further comprising;
adjustments to the profile that cause an individual relays contacts to make at zero AC power-line voltage;
adjustments to the profile that cause an individual relays contacts to break before zero load current.

11. The relay control according to claim-10, further comprising diagnostics including;
controlling the make profile rate of change such that it rises to different adjustable magnitudes of coil current in a fixed time period;
limiting the range of adjustment of coil current around the coil current of a known working standard relay.

12. The relay control according to claim-10, further comprising automated make adjustment including;
means of comparing relay coil voltage to a set reference make voltage and producing an edge directed make-signal;
means of comparing AC power-line voltage to zero voltage and producing a zerox-signal;
means of comparing the difference in time between said make-signal edge and zerox-signal;
correcting the make profile such that said time difference is zero.

13. The relay control according to claim-10, further comprising automated break adjustment including;
means of comparing relay coil voltage to a set reference break voltage and producing an edge directed break-signal;
means of comparing load current to zero current and producing a zeroi-signal;
means of comparing the difference in time between said break-signal edge and zeroi-signal;
correcting the break profile such that said time difference is zero.

14. The relay control according to claim-7, further comprising;
comparing means providing an opposite polarity edge at high AC power-line voltage and a clock-edge polarity at zero AC power-line voltage and no clock-edge polarity output unless both AC power-line voltages occur in sequence;
providing a data signal in a first polarity signifying relay make and data signal in second polarity signifying relay break;
flip-flop means whose output follows said data signal after said clock-edge occurs;
logical means such that a flip-flop output change in a first polarity produces a logic output that instantly starts the relay make profile;
logical means such that a flip-flop output change in a second polarity produces a delay followed by a logic output that starts the relay break profile;

15. A relay control improvement comprising;
electrical storage means to maintain relay coil power during a power-line loss;
logical means such that when the relay coil is off, a logic-signal stops the relay from being energized until said storage means charges above a predetermined level;
logical means such that when the relay coil is energized, it disables said logic-signal until said storage means discharges below a predetermined level.

16. A relay control improvement comprising;
a grounded conductive plane sharing surface area capacitance with the relay its associated electronic circuitry, and interconnections;
a power supply whose transformer shield, laminations, and/or center tap connect to said ground plane;
a relay coil pin joined to wire turns located at the bottom layer of its bobbin, those closest to its iron core, and connecting to said ground plane;
a capacitor connecting between the relay coil pins;
a choke connecting to the ungrounded relay pin;
a transistor driving said choke from the ungrounded leg of said power supply.
